(19) United States
(12) Patent Application Publication
(10) Pub. No.: US 2025/0221432 A1
(43) Pub. Date: Jul. 10, 2025

(54) ENERGIZED BEVERAGE

(71) Applicant: John F. Warlick, Talking Rock, GA (US)

(72) Inventor: John F. Warlick, Talking Rock, GA (US)

(21) Appl. No.: 18/406,462

(22) Filed: Jan. 8, 2024

(51) Int. Cl. A23L 2/38; C12G 3/08

(52) U.S. Cl. CPC A23L 2/38; C12G 3/08

(57) ABSTRACT

A liquid beverage having a composition of stimulated energized fluid has a quantity of fluid; and enhanced molecules treated with acoustic shock waves or pressure pulses dispersed in the quantity of fluid. The quantity of fluid after being treated with the acoustic shock waves exhibits an increased entropy. The enhanced molecules are stimulated to enhance absorption when consumed increasing the energy absorbed by a drinker. In one embodiment, the beverage is an alcoholic beverage. The alcoholic beverage can be a beer, wine or whiskey. An alcohol percentage is increased after the acoustic shock wave treatment. In another embodiment, the beverage is a non-alcoholic energy booster drink. In yet another embodiment, the beverage is water.

### TECHNICAL FIELD

The present invention relates to a treatment for fluids or liquids, more particularly beverages. The treatment uses acoustic shock waves to impart a molecular change in the beverage.

### BACKGROUND OF THE INVENTION

Several inventors have been involved in the development of acoustic sound waves or pressure pulses over the last decade in the treatment of tissue and organs. These discoveries have led the medical community in a variety of breakthrough medical treatments for a variety of conditions.

Recently, one of these same inventors discovered a unique way to treat beverages using acoustic shock waves. This novel treatment is described herein.

### SUMMARY OF THE INVENTION

A liquid beverage having a composition of stimulated energized fluid has a quantity of fluid; and enhanced molecules treated with acoustic shock waves or pressure pulses dispersed in the quantity of fluid. The quantity of fluid after being treated with the acoustic shock waves exhibits an increased entropy. The enhanced molecules are stimulated to enhance absorption when consumed increasing the energy absorbed by a drinker. In one embodiment, the beverage is an alcoholic beverage. The alcoholic beverage can be a beer, wine or whiskey. An alcohol percentage is increased after the acoustic shock wave treatment. In another embodiment, the beverage is a non-alcoholic energy booster drink. In yet another embodiment, the beverage is water.

A method of stimulating and energizing a fluid has the steps of; activating an acoustic shock wave or pressure pulse generator to emit acoustic shock waves or pressure pulses directed to impinge the fluid; and subjecting the fluid to the acoustic shock waves or pressure pulses to form a stimulated and energized fluid. The emitted acoustic shock waves or pressure pulses are of a low energy. The emitted shock waves or pressure pulses are convergent, divergent, planar or near planar.

The emitted shock waves or pressure pulses stimulate the fluid in the absence of cavitation. The step of activating the acoustic shock wave generator or source emits low energy or unfocused acoustic shock waves, wherein the acoustic shock waves are waves having amplitudes above 0.1 MPa and rise times of the amplitude are below 100 nano-seconds with a duration of a shock wave being below 3 micro-seconds for the positive part of a cycle and wherein the pressure pulses are an acoustic pulse which includes several cycles of positive and negative pressure with amplitudes of the positive part of such a cycle being above 0.1 MPa and the pressure pulse time duration is from below a microsecond to about a second, rise times of the positive part of the first pressure cycle is in the range of nano-seconds up to several milli-seconds.

### Definitions

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

Extracorporeal membrane oxygenation (ECMO) is a technique of life support that consists of diverting a fraction of the patient's blood flow (BF) through an artificial lung for gas exchange (oxygenation and carbon dioxide [CO2] removal) and then returning it to the patient.

“Extracorporeal” occurring or based outside the living body.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms). Very fast pressure pulses are called shock waves. Shock waves used in medical applications do have amplitudes above 0.1 MPa and rise times of the amplitude can be below 1000 ns, preferably at or below 100 ns. The duration of a shock wave is typically below 1-3 micro-seconds (μs) for the positive part of a cycle and typically above some micro-seconds for the negative part of a cycle. These typical time durations can be compressed by employing very high frequency devices of 1000 Hz or more while still maintaining a symmetric profile of a shock wave all of which are included within the scope of the present invention. In addition to the more common sources of shock wave or pressure pulse generators such as radial, spherical, electrohydraulic, piezoelectric and ballistic generators, the present invention contemplates laser generators. Laser generators produce numerous tiny acoustic waves as the laser beam pulses. The lower energy shock waves generated by lasers mimic the more conventional sources of sound waves and are therefore to be included herein.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Washington 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a simplified depiction of a pressure pulse/shock wave (PP/SW) generator with focusing wave characteristics.

FIG. 2 is a simplified depiction of a pressure pulse/shock wave generator with plane wave characteristics.

FIG. 3 is a simplified depiction of a pressure pulse/shock wave generator with divergent wave characteristics.

FIG. 4 is a perspective view of a shock wave generator device.

FIG. 5 is a graph showing an exemplary ultrasound wave pattern.

FIG. 6 is a graph of an exemplary acoustic shock wave pattern.

FIG. 7 is an exemplary container of liquid beverage being treated with acoustic shock waves.

FIG. 8 is an alternative treatment for liquid beverages during processing.

### DETAILED DESCRIPTION OF THE INVENTION

As acoustic shock waves pass through liquids, some of the kinetic energy is converted to potential energy that is absorbed or stored in the molecules of the liquid.

These molecules then have more energy releasing potential when consumed than untreated liquids or beverages. Liquids have more kinetic energy than solids. If heat energy is added to the liquid, the particles will move faster as their kinetic energy is increased. Some of the particles may even have enough kinetic energy to break their liquid bonds and escape as a gas.

Shock waves also cause an increase in entropy in the treated liquid or beverage. This entropy is a physical property that depends on its internal energy and external parameters that is most commonly associated with a state of disorder, randomness, or uncertainty.

In physics, a shock wave, or shock, is a type of propagating disturbance that moves faster than the local speed of sound in the medium. Like an ordinary wave, a shock wave carries energy and can propagate through a medium but is characterized by an abrupt, nearly discontinuous, change in pressure, temperature, and density of the medium.

The goal in beverage production according to the present invention is to provide 100 to 3000 acoustic shock waves or pressure pulses at a voltage of 5 kV to 28 kV across a spark gap generator, electromagnetic, piezoelectric or a ballistic wave generator in a single processing treatment preferably or one or more adjuvant treatments by impinging the emitted waves on the fluid during its manufacture and processing prior to final packaging into containers. These shock wave energy transmissions are effective in stimulating a molecular change or reaction and can be accomplished with or without creating the cavitation bubbles in the fluid. The underlying principle of these shock wave treatments is to add energy to the fluid via the molecular change imparted into the fluid.

The unfocused shock waves or pressure pulses can be of a divergent wave pattern or near planar pattern preferably of a low peak pressure amplitude and density. Typically, the energy density values of the shock waves range as low as 0.000001 mJ/mm² and having a high-end energy density of below 1.0 mJ/mm², preferably 0.40 mJ/mm² or less, more preferably 0.20 mJ/mm² or less. The peak pressure amplitude of the positive part of the cycle should be in the rage of nano-second up to some milliseconds and its duration is below 1-3 microseconds.

The pressure pulse is much slower, a “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms).

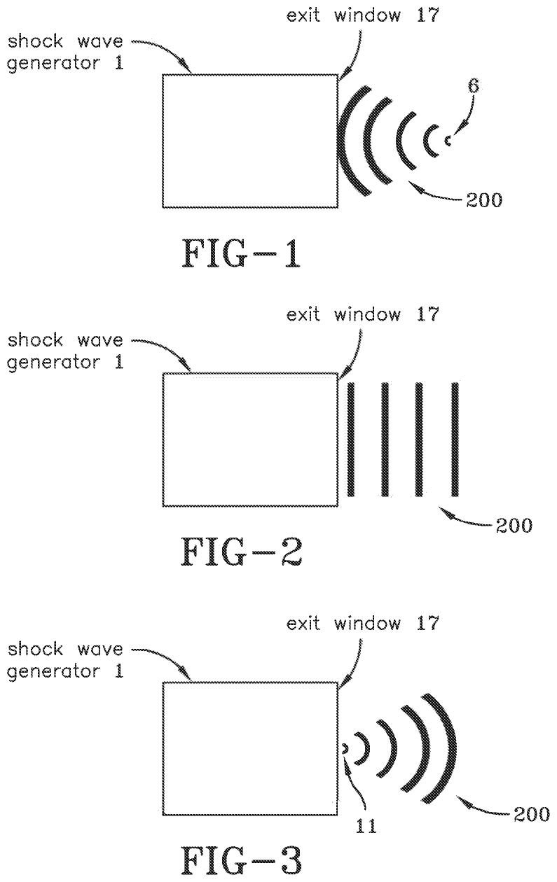

The following invention description first provides a detailed explanation of acoustic shock waves or pressure pulses, as illustrated in FIGS. 1-4. As used herein an acoustic shock wave is an asymmetric wave with an exceptionally rapid peak rise time and slower return time from the peak amplitude. Historically, these acoustic shock waves or pressure pulses were first used medically to destroy kidney stones. The wave patterns were directed to a focal point with a relatively high energy to blast the concrements into small urinary tract passable fragments.

A whole class of acoustic shock waves or pressure pulses for medical treatments were later discovered that employed low energy acoustic shock waves or pressure pulses. These low energy acoustic shock waves or pressure pulses maintained the asymmetric wave profile, but at much lower energies as described in US2006/0100550 which is incorporated herein in its entirety. These low energy acoustic shock waves or pressure pulses advantageously could stimulate blood without requiring a focused beam. The advantage of such an unfocused beam was the acoustic wave could be directed to pass through a container or tubing filled with blood without causing any cell rupturing which would be evidenced by a lack of cell membrane damage. This use of unfocused, low energy acoustic shock waves or pressure pulses provided an ability to treat a large volume of blood.

The use of low energy acoustic shock waves or pressure pulses that employ a focused beam has been spurred on as a viable alternative to the unfocused low energy shock waves because the focal point being of a small point of energy has little or a small region of cell damage as the remaining portions of the wave pattern can provide a stimulating effect similar to the unfocused shock waves. Basically, the effect is the same with the users of focused waves achieving the benefits of the unfocused waves, but with a focal point of peak energy in a tiny localised region. So, for purposes of the present invention, the use of “soft waves” those defined by low energy beams will be applicable to both focused and unfocused beams of acoustic shock waves or pressure pulses for the present invention.

One last and significant point that the reader must appreciate is that an “acoustic shock wave” is not an “ultrasound wave”. Sonic or ultrasound waves are generated with a uniform and symmetrical wave pattern similar to a sinusoidal wave. This type of sonic wave causes a sheer action on fluids as evidenced by a generation of heat within the fluids, for this reason, the use of sonic waves of the ultrasonic type are not considered as efficient in increasing molecular energy rates. The present invention provides an apparatus for an effective treatment of fluids, which benefit from high or low energy pressure pulse/shock waves having focused or unfocused, nearly plane, convergent or even divergent characteristics. With an unfocused wave having nearly plane, plane, convergent wave characteristic or even divergent wave characteristics, the energy density of the wave may be or may be adjusted to be so low that adverse side effects do not exist at all. In manufacturing beverages, side effects include adversely affecting the taste, color or appearance or reducing alcohol content among others.

In certain embodiments, the apparatus of the present invention is able to produce waves having energy density values that are below 0.1 mJ/mm² or even as low as 0.000 001 mJ/mm². In a preferred embodiment, those low-end values range between 0.1-0.001 mJ/mm². With these low energy densities, side effects are reduced, and the dose application is much more uniform. The apparatus of the present invention also may allow the user to make more precise energy density adjustments than an apparatus generating only focused shock waves, which is generally limited in terms of lowering the energy output.

With reference to FIGS. 1-3, a variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns. FIGS. 1-3 show various shock waves 200 being transmitted from a shock wave generator 1.

FIG. 1 is a focused shock wave wherein the shock wave pattern emits from an exit window 17 and focuses to a point or localized area 6 as illustrated. The wave form 200 is considered a converging wave form. FIG. 1 is a simplified depiction of a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The fluid is generally located in or near the focal point which is located in or near position 6. At position 17 a water cushion or any other kind of exit window for the acoustical energy is located.

In FIG. 2, the shock wave emits from the exit window 17 in a planar fashion wherein the wave forms 200 are transmitted parallel to the exit window 17 and transmitted into the fluid. FIG. 2 is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even (also referred to herein as “disturbed”) wave characteristics can be generated, in case a paraboloid is used as a reflecting element, with a point source (e.g. electrode) that is located in the focal point of the paraboloid. The waves will be transmitted into a container or fluid via a coupling media such as, e.g., ultrasound gel or oil and their amplitudes will be attenuated with increasing distance from the exit window 17.

In FIG. 3, the wave form 200 is emitted from the exit window 17 in such a fashion that the focal point is near the exit window 17 and the wave form 200 expands outwardly, this is considered a divergent wave form wherein the wave form expands as it leaves the exit window 17 in a diverging pattern. FIG. 3 is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. In FIG. 3 the pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup.

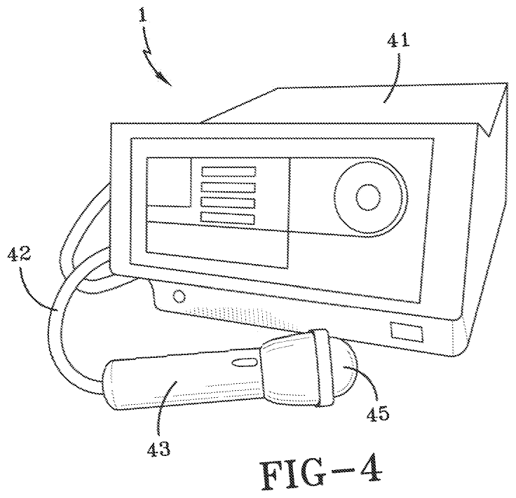

FIG. 4 shows an exemplary shock wave device generator or source 1 with a control and power supply 41 connected to a hand-held applicator shock wave head 43 via a flexible hose 42 with fluid conduits. The illustrated shock wave applicator 43 has a flexible membrane 45 at an end of the applicator 43 which transmits the acoustic waves when coupled to the external surface of tissue of an appendage by using a fluid or acoustic gel. As shown, this type of applicator 43 has a hydraulic spark generator using either focused or unfocused shock waves, preferably in a low energy level, less than the range of 0.01 mJ/mm² to 0.3 mJ/mm². The flexible hose 42 is connected to a fluid supply that fills the applicator 43 and expands the flexible membrane 45 when filled. Alternatively, a ballistic, piezoelectric or spherical acoustic shock wave device can be used to generate the desired waves. The fluid expands a flexible membrane 45 in such a fashion that the membrane 45 extends outwardly in a balloon shape fashion as illustrated in FIG. 4.

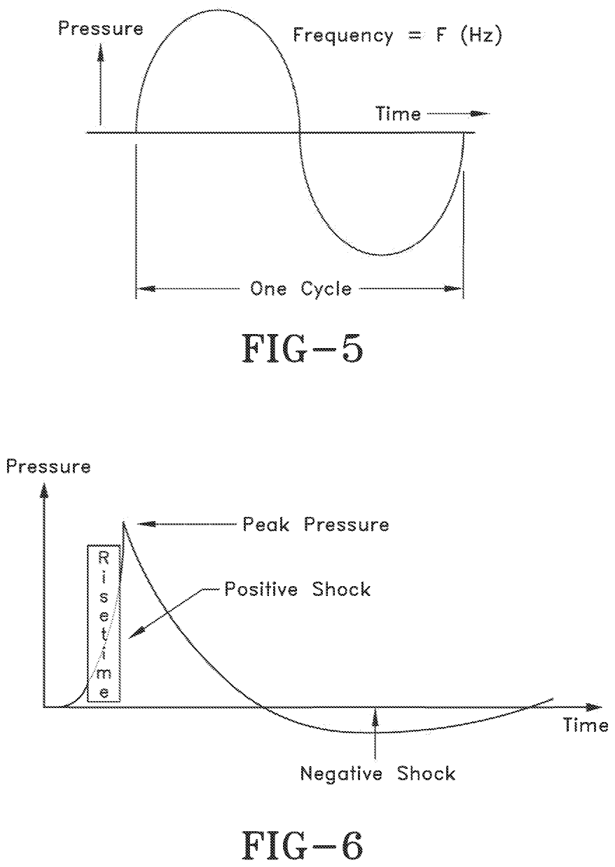

An important aspect of the present invention is that the pressure waves from the acoustic shock wave generator have an asymmetric type wave form with a very high peak pressure that occurs over a very short rise time. The positive shock is transmitted in a very quick fashion as defined which defines the features of an acoustic shock wave or pressure pulse. The negative portion of the wave is longer in duration and encompasses the rest of the wave form as shown in FIG. 6. This is unlike ultrasound wave forms which are symmetrical, sinusoidal in shape as illustrated in FIG. 5. The main difference between an acoustic shock wave and an ultrasound wave is that there is no heat generated in the asymmetric type acoustic shock wave whereas there is heat generation in the ultrasound wave. The ultrasound wave therefore is considered inferior for the purposes of present invention or any other treatment for that matter compared to the use of the electrohydraulic acoustic shock waves emitted from the applicator 43. The applicator 43 as shown is electrohydraulic, but it could be ballistic, piezoelectric or any other form of applicator exhibiting the asymmetrical waves. The asymmetric acoustic wave pattern shown in FIG. 6 is contrasted to an ultrasonic wave pattern which is illustrated in FIG. 5. As shown, ultrasound waves are symmetrical having the positive rise time equal to the negative in a sinusoidal wave form. These ultrasound waves generate heat in the tissue and are accordingly believed not suitable for use on tissue requiring a cellular or molecular stimulation to achieve the desired goals of the treatment method.

This apparatus, in certain embodiments, may be adjusted/modified/or the complete shock wave head or part of it may be exchanged so that the desired and/or optimal acoustic profile such as one having wave fronts with focused, planar, nearly plane, convergent or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combinations of shock wave therapies. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the various types of acoustic shock waves or pressure pulses and types of shock wave generating heads provides versatility, the person skilled in the art will appreciate that apparatuses that produce low energy or soft acoustic shock waves or pressure pulses having, for one example, nearly plane characteristics, are less mechanically demanding and fulfill the requirements of many users.

As the person skilled in the art will also appreciate that embodiments shown in the drawings are independent of the generation principle and thus are valid for not only electrohydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a container or tubing filled with fluid is coupled via ultrasound gel or oil to the acoustic exit window (17), which can, for example, be an acoustic transparent membrane, a water cushion, a plastic plate or a metal plate.

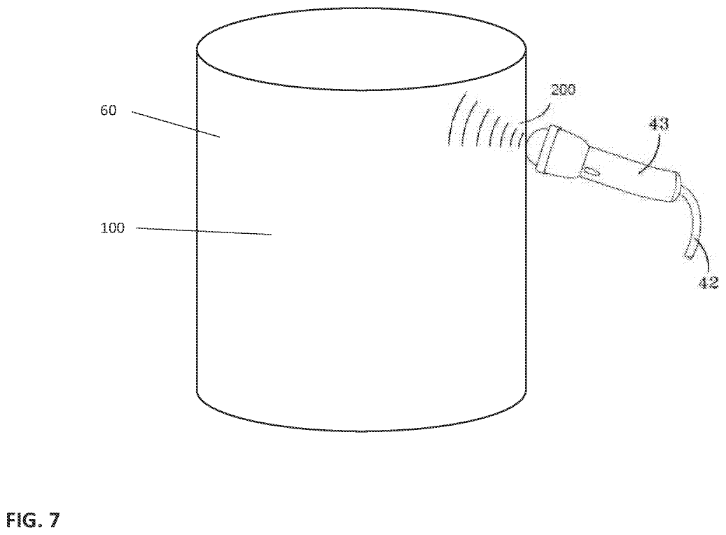

FIG. 7 illustrates an example of an applicator 43 in contact with a container 60 of liquid beverage 100 being treated with acoustic shock waves 200. A shock wave applicator head 43 is brought into contact with the container 60 of fluid 100 preferably an acoustic gel is used to enhance the transmission of the shock waves 200 through the container 60. The shock wave applicator head 43 is connected via cabling 42 to a power generating unit 41. The shock wave applicator head 43 can be attached rigidly to a fixture or stand or alternatively can be hand held and manipulated across the fluid to drive the shock waves 200 in the direction the shock wave head 43 is pointed to activate a molecular response.

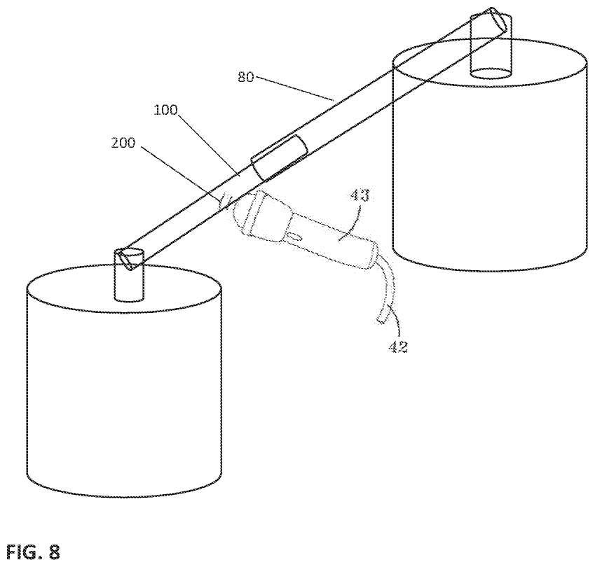

FIG. 8 shows a fluid treatment device, by way of example a device that can be used with a pressure pulse/shock wave generator applicator 43 treating the fluid 100 as it passes through tubing 80. The acoustic shock waves 200 impinge the liquid beverage or fluid 100 as it passes through the tubing 80 to enhance the molecules of the fluid 100.

The present invention employs the use of pressure pulses or shock waves to energize fluid. It changes fluid on a molecular level. Energy can be stored in the fluid as well as any additives incorporated in the fluid. Shockwave energy can be added to bathing water for example, or to beer or any other “drink” to add energy. The world's first true energy beverage. For example, in the drink/beer/coffee making process, shockwaves squeeze/sheer cells causing them to express more flavonoids, nutrients and other intracellular components including exosomes. Cells are squeezed of their nutrients and flavors. In the case of beer, yeast becomes more efficient in the brewing process producing higher alcohol content and flavors and hops can be reduced in a recipe with the same flavors as more flavors are expressed from a given quantity. Theoretically shock wave enhanced energy drinks can make the user smarter and more aware and give them energy.

The transmission dosage can be from a few seconds to 20 minutes or more dependent on the desired energy level. Preferably the waves are generated from an unfocused or focused source. The unfocused waves can be divergent, planar or near planar and having a low pressure amplitude and density in the range of 0.00001 mJ/mm² to 1.0 mJ/mm² or less, most typically below 0.2 mJ/mm². The focused source preferably can use a diffusing lens or have a far-sight focus to minimize if not eliminate having the localized focus point within the tissue. Preferably the focused shock waves are used at a similarly effective low energy transmission or alternatively can be at higher energy but wherein the target site is disposed pre-convergence inward of the geometric focal point of the emitted wave transmission. This emitted energy preferably stimulates the fluid adding energy. The shock waves squeeze or sheer cells causing them to express more flavonoids, nutrients and other intracellular components including exosomes. Cells are squeezed of their nutrients and flavors.

Beer is made from grain, hops, yeast and water. Common grains are barley, sorghum, wheat and rye. The first step in making beer is malting, this is the process of soaking seeds to begin germination then drying/heating the grains until they are dry and brittle to expose the enzymes in the grains. Second: mashing, crush or mill and steep, soak the malted grains in warm/hot water for around an hour, this activates the exposed enzymes which release sugar, the sugary liquid called wort is drained. Third: the wort is boiled another hour to concentrate the sugar and sterilize, hops are added as well as other spices/flavors. Hops are naturally bitter which counterbalances the sweetness of the wort and hops are a natural preservative. Fourth: filter the boiled liquid, transfer to a fermentation vessel and add yeast, microorganism. This converts the sugar to alcohol, ethanol and carbon dioxide. Fifth: store the fermenting beer at a specific temperature and length of time depending on the end result desired. Most beers take a week to ferment. After fermenting, beer is stored for carbonation or maturing. Carbonation can be increased by transferring to a pressure vessel (keg) and adding carbon dioxide or by transferring before fermentation is finished so carbon dioxide builds up in the container.

Whiskey and other higher content alcoholic beverages are made similarly but with an added distillation process of extreme heating and cooling repeatedly to concentrate or make a more pure alcohol. Then the liquor is aged, often for several years.

Alcoholic beverages in beer making and wine or whiskey making all benefit from the use of molecule enhancing acoustic shock wave treatment. Even water can be enhanced as well as non-alcoholic energy drinks.

Due to the wide range of beneficial treatments available it is believed preferable that the optimal use of one or more wave generators or sources should be selected on the basis of the specific application.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of stimulating and energizing a fluid comprises the steps of:
activating an acoustic shock wave or pressure pulse generator to emit acoustic shock waves or pressure pulses directed to impinge the fluid; and
subjecting the fluid to the acoustic shock waves or pressure pulses to form a stimulated and energized fluid.

2. The method of claim 1, wherein the emitted acoustic shock waves or pressure pulses are of a low energy.

3. The method of claim 1, wherein the emitted shock waves or pressure pulses are convergent, divergent, planar or near planar.

4. The method of claim 1, wherein the emitted shock waves or pressure pulses stimulate the fluid in the absence of cavitation.

5. The method of claim 1, wherein the step of activating the acoustic shock wave generator or source emits low energy or unfocused acoustic shock waves, wherein the acoustic shock waves are waves having amplitudes above 0.1 MPa and rise times of the amplitude are below 100 nano-seconds with a duration of a shock wave being below 3 micro-seconds for the positive part of a cycle and wherein the pressure pulses are an acoustic pulse which includes several cycles of positive and negative pressure with amplitudes of the positive part of such a cycle being above 0.1 MPa and the pressure pulse time duration is from below a microsecond to about a second, rise times of the positive part of the first pressure cycle is in the range of nano-seconds up to several milli-seconds.

6. A liquid beverage having a composition of stimulated energized fluid comprises:
a quantity of fluid; and
enhanced molecules treated with acoustic shock waves or pressure pulses dispersed in the quantity of fluid.

7. The liquid beverage of claim 6, wherein the quantity of fluid after being treated with the acoustic shock waves exhibits an increased entropy.

8. The liquid beverage of claim 6, wherein the enhanced molecules are stimulated to enhance absorption when consumed increasing the energy absorbed by a drinker.

9. The liquid beverage of claim 6, wherein the beverage is an alcoholic beverage.

10. The liquid beverage of claim 9, wherein the alcoholic beverage is a beer, wine or whiskey.

11. The liquid beverage of claim 10, wherein an alcohol percentage is increased after the acoustic shock wave treatment.

12. The liquid beverage of claim 6 wherein the beverage is a non-alcoholic energy booster drink.

13. The liquid beverage of claim 6 wherein the beverage is water.
